(19) United States
(12) Patent Application Publication
(10) Pub. No.: US 2008/0226778 A1
(43) Pub. Date: Sep. 18, 2008

(54) METHODS FOR PROCESSING FOOD FOR CONSUMPTION BY INDIVIDUALS HAVING DIFFICIULTY CHEWING AND/OR SWALLOWING

(76) Inventors: Shahzar Amirali Visram, Brooklyn, NY (US); Jessica Thatcher Crolick Rolph, Edina, MN (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/687,364

(22) Filed: Mar. 16, 2007

(51) Int. Cl. A23L 1/48

(52) U.S. Cl. 426/231

(57) ABSTRACT

A method for processing food for consumption by individuals having difficulty chewing and/or swallowing includes providing food having a consistency of at least one of a thick liquid, a thick liquid having chunks, and between a thin liquid and a medium liquid, subjecting the provided food to at least one pre-determined pressure that is above atmospheric pressure for a pre-determined amount of time, and releasing the food from the pre-determined pressure.

### BACKGROUND OF THE INVENTION

This invention relates generally to processed foods, and more specifically to methods for processing food for consumption by individuals that have difficulty chewing and/or swallowing.

A significant portion of the adult population is unable to consume at least some known food because of an illness or an infirmity which lessens the individual's ability to chew or swallow conventionally prepared solid food. For example, such individuals may include people suffering from dental or muscular dysfunctions, paralysis, neurodegenerative and musculodegenerative disorders, strokes, and/or general geriatric infirmity. Similarly, newborn children generally lack the ability to chew at least some foods until they have fully developed their swallowing muscular control and/or until they are around three to four years of age and have developed a full set of teeth and learned to adequately chew their food prior to swallowing.

Currently, such individuals are generally forced to resort to consuming pre-packaged food that has been canned, frozen, or to which artificial additives have been added, and that has been pureed or has been altered in some other manner, such as through mashing, in order to obtain basic nutritional sustenance. More specifically, the predominant current method of preparing such food involves first, mashing or processing a conventional food using a food processor or other similar, particle-reducing device, and then mixing the resulting composition with lubricating or thickening agents which prevent aspiration upon ingestion. Canning such foods may undesirably deplete the food of nutrients and/or vitamins. Furthermore, the resulting processed food product, when canned, is generally an unattractive and/or unappetizing mass of food which retains little of its original flavor or texture, and little or none of its original appearance.

Moreover, to reduce the likelihood of illness caused by food-borne pathogens, at least some of such processed foods are preserved prior to being transported to, and/or stored at, a food retailer. For example, artificial additives and/or preservatives are added to at least some known processed foods in a quantity and in a mixture that ensures an adequate shelf life for the food is created. Specifically, antimicrobial preservatives and antioxidant preservatives are typically added to such food to prevent the growth of molds, yeasts, or bacteria, and to keep foods from becoming rancid, browning, or developing black spots. Such preservatives may include substances that if taken alone may be harmful to an individual.

Other known processed foods which may be susceptible to contamination are preserved via a freezing process in which the food is exposed to freezing, or sometimes lower, temperatures. However, the use of freezing equipment generally increases the processing time and costs associated with processing such food. In addition, processing foods in such a manner may degrade the taste of the food. Moreover, as a result of such processing, it may take additional time and/or effort for parents and/or other caregivers to prepare such food for consumption, as such food may need to be thawed prior to being consumed. Anytime food must be thawed prior to consumption, the risks of buildup of harmful bacteria on perishable food, which in turn may cause food-borne illness, are generally increased.

### BRIEF DESCRIPTION OF THE INVENTION

In one aspect, a method is provided for processing food for consumption by individuals having difficulty chewing and/or swallowing. The method includes providing food having a consistency of at least one of a thick liquid, a thick liquid having chunks, and between a thin liquid and a medium liquid, subjecting the provided food to at least one pre-determined pressure that is above atmospheric pressure for a pre-determined amount of time, and releasing the food from the pre-determined pressure.

In another aspect, a method is provided for processing food for consumption by individuals having difficulty chewing and/or swallowing. The method includes providing food having a consistency of at least one of a thick liquid, a thick liquid having chunks, and between a thin liquid and a medium liquid, subjecting the provided food to at least one pre-determined pressure that is above atmospheric pressure for a pre-determined amount of time, releasing the food from the pre-determined pressure, and packaging the food.

### BRIEF DESCRIPTION OF THE DRAWINGS

FIG. 1 is flowchart illustrating an exemplary embodiment of a method for processing food for consumption by individuals that may have difficulty chewing and/or swallowing.

FIG. 2 is a schematic illustration of an exemplary conduit that may be used to process food.

FIG. 3 is a schematic illustration of an exemplary piston apparatus that may be used to process food.

FIG. 4 is a schematic illustration of an exemplary pressure vessel that may be used to process food.

### DETAILED DESCRIPTION OF THE INVENTION

As used herein, the term “high pressure processing” is defined as subjecting food to a pressure that is above atmospheric pressure for a pre-determined amount of time. As used herein, the term “sterilizing” is defined as rendering micro-organisms, micro-organism spores, micro-organism enzymes, microbial cells, microbial cell spores, and/or microbial enzymes less harmful and/or dangerous, relative to an individual consuming food, and/or relative to a desired quality of food, such as, but not limited to, a taste of the food, shelf-life of the food, and/or texture of the food. As used herein, the term “preserving” is defined as prolonging and/or extending a shelf-life of food. As used herein, the term “human baby” is defined as a human that is equal to, or less than, four years of age. As used herein, the term “human geriatric” is defined as a human that is equal to, or greater than, seventy years of age. As used herein, the term “baby food” is defined as food suitable for consumption by human babies. As used herein, the term “geriatric food” is defined as food suitable for consumption by human geriatrics. As used herein, the term “baby and/or geriatric food” is defined as food suitable for consumption by human babies and/or human geriatrics.

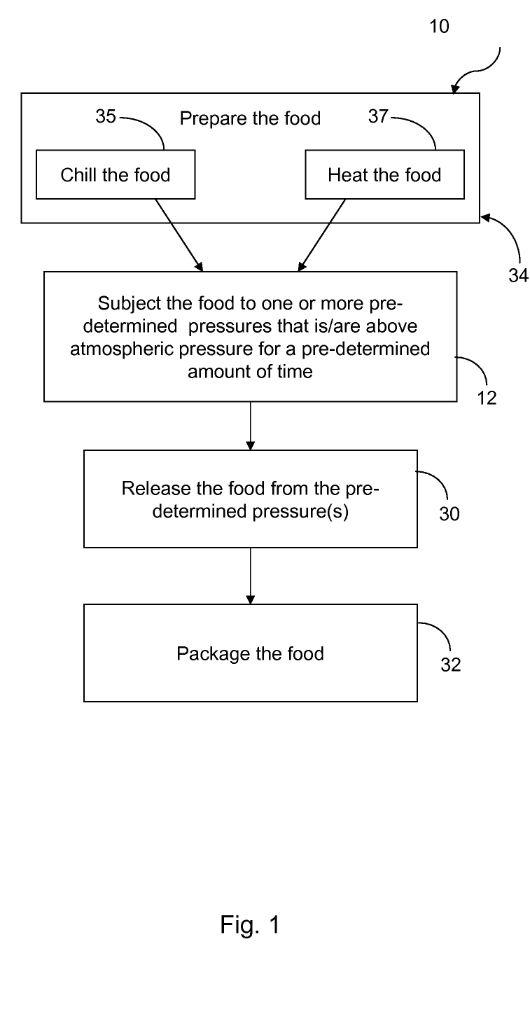

FIG. 1 is a flowchart illustrating an exemplary embodiment of a method 10 for processing food for consumption by individuals having difficulty chewing and/or swallowing. For example, food for consumption by individuals having difficulty chewing and/or swallowing may include, but is not limited to, food having a consistency of: (1) between a thin liquid, such as, but not limited to, the consistency of water or juice, and a medium liquid, such as, but not limited to, the consistency of a nectar; (2) a thick liquid, such as, but not limited to, the consistency of a yogurt or a pudding; and/or (3) a thick liquid having chunks, such as, but not limited to, the consistency of a yogurt or a pudding with pearl-sized chunks. In some embodiments, method 10 is used to process baby food and/or geriatric food. In other embodiments, the food processed using method 10 is not baby and/or geriatric food. In some embodiments, method 10 is used to process organic food, wherein “organic food” is defined as any food that is produced to include less than 10% by weight or volume of genetically modified organisms (GMOs) and synthetic chemicals, such as, but not limited to synthetic pesticides, preservatives, herbicides, fertilizers, antibiotics, and/or hormones. In some embodiments, food processed using method 10 is non-organic. In some embodiments, the food processed using method 10 does not include any preservatives. Alternatively, in other embodiments, method 10 includes processing food that includes at least one preservative.

Method 10 includes subjecting 12 the food to high pressure processing, sometimes referred to as high pressure preservation, to facilitate at least partially sterilizing, and/or preserving, the baby and/or geriatric food. For example, in the exemplary embodiment, method 10 includes subjecting 12 the food to one or more pre-determined pressures that is/are above atmospheric pressure for a pre-determined amount of time. The pre-determined pressure(s) above atmospheric pressures facilitate disrupting and/or destroying micro-organisms, spores of micro-organisms, microbial cells, and/or spores of microbial cells with the food, and/or facilitate de-activating micro-organism enzymes and/or microbial enzymes within the food. As such, the pre-determined pressure(s) facilitate sterilizing and/or preserving the food.

In some embodiments, the food is subjected 12 substantially continuously to the pre-determined pressure(s) above atmospheric pressure during processing. In alternative embodiments, the food is subjected 12 to the pre-determined pressure(s) either once during processing, or at timed intervals during processing. In such embodiments, the food is not continuously subjected 12 to the pre-determined pressure(s), but rather batch and/or semi-continuous subjection 12 is used to process the food. It should be noted that the food may be subjected 12 to any pre-determined pressure(s) above atmospheric pressure. For example, in some embodiments, the food is subjected to one or more pressures equal to, or greater than, 10 MPa, such as, but not limited to one or more pressures of from about 100 MPa to about 1000 MPa. Moreover, and for example, in some embodiments, the food is subjected to one or more pressures of from about 25,000 psi (pounds per squre inch) to 75,000 psi for a pre-determined amount of time. The amount of time that the food is subjected to the increased pressure varies depending on a number of properties of the food, including, but not limited to the pH of the food and/or the composition of the food. For example, in one embodiment, the food is pressurized for between five to fifteen minutes. Moreover, the pre-determined pressure is not limited to being between about 25,000 psi to 75,000 psi, but rather is selected to be high enough to facilitate inactivating microorganisms.

In some embodiments, as the food is subjected 12 to the pre-determined pressure(s), a temperature of the food increases due to adiabatic heating. Once the food is released from the pre-determined pressure(s) and is no longer subjected to the pre-determined pressure(s), as will be described below, the temperature of the food may return to about its pre-pressurization temperature.

In some embodiments, the food is subjected 12 to the pre-determined pressure(s) above atmospheric pressure under conditions that facilitate reducing heat transfer from the food to any surrounding materials and/or substances. For example, in some embodiments, a temperature of the food and a temperature of surrounding materials and/or substances is about the same as the food is subjected 12 to the pre-determined pressure(s), or a temperature of the surrounding materials and/or substances is greater than a temperature of the food while it is subjected 12 to the pre-determined pressure(s). Moreover, in some embodiments, some, or all, of any surrounding materials and/or substances may undergo an increase in temperature that is about the same increase in temperature as the food being subjected 12 to the pre-determined pressure(s).

The food may be subjected 12 to any or each of a plurality of pre-determined pressures above atmospheric pressure for any period of time. For example, in some embodiments, the food is subjected 12 to each of the pre-determined pressures for between about five minutes and about fifteen minutes. The period of time the food is subjected 12 to the pre-determined pressure(s) is variably selected to facilitate completely or partially sterilizing and/or preserving the food and may depend upon a variety of factors, such as, but not limited to, the type of food being processed and/or the value(s) of the pre-determined pressure(s) that the food is subjected 12 to.

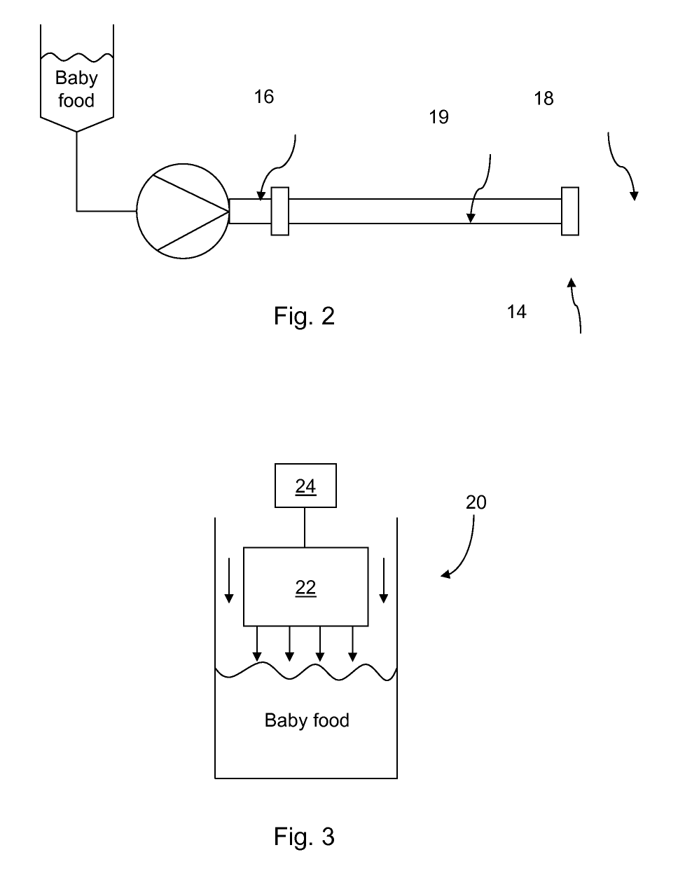

The food may be subjected 12 to the pre-determined pressure(s) using any suitable, structure, method, process, and/or means. For example, in some embodiments, the food is subjected 12 to the pre-determined pressure(s) by channeling the food through a conduit that includes a portion, such as, but not limited to, an outlet, having a reduced size with respect to other portions of the conduit, such as, but not limited to an inlet and/or some or all of a portion extending between the inlet and the outlet, such that the conduit has a pressure difference between an inlet and the outlet thereof. Although the food may be subjected 12 to the pre-determined pressure(s) using any suitable conduit, FIG. 2 illustrates a schematic illustration of an exemplary conduit 14 that may be used to process the food. More specifically, and for example, in the exemplary embodiment, conduit 14 includes an inlet 16 and an outlet 18. Outlet 18 has a reduced size as compared with inlet 16 and/or some or all of a portion 19 of conduit 14 extending between inlet 16 and outlet 18. As such, inlet 16 and outlet 18 have a pre-determined pressure difference therebetween such that food channeled therethough is subjected 12 to the pre-determined pressure(s).

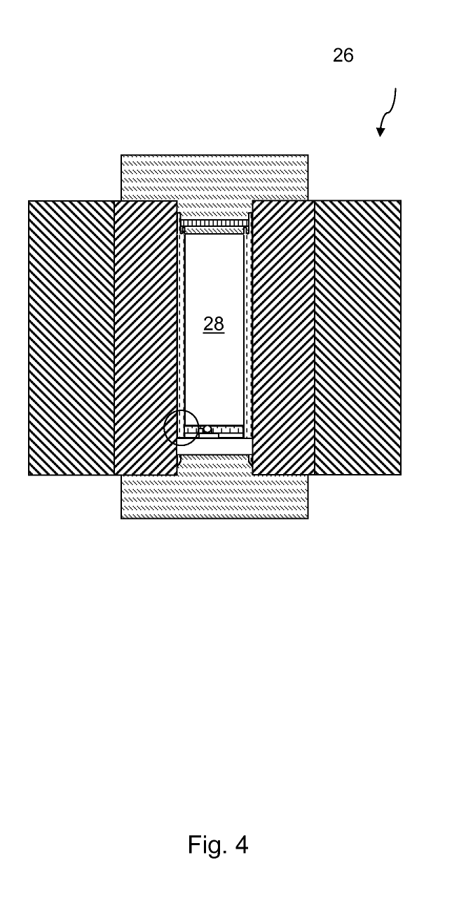

Another example of structure and/or means for subjecting 12 the food to the pre-determined pressure(s) includes using a suitable piston apparatus to apply pressure to the food. For example, FIG. 3 is a schematic illustration of an exemplary piston apparatus 20 that may be used to subject 12 the food to the pre-determined pressure(s). In the exemplary embodiment, piston apparatus 20 includes a piston 22 coupled to an actuator 24. Actuator 24 control actuation of piston 20 to cause pressure to be induced to the food, as shown in FIG. 3. Yet another example of structure and/or means for subjecting 12 the food to the pre-determined pressure(s) includes the use of a pressure vessel. For example, FIG. 4 is a schematic illustration of an exemplary pressure vessel 26 that may be used to subject 12 the food to the pre-determined pressure(s). For example, using a pressure vessel 26, the food is first positioned within a chamber 28 of the pressure vessel, chamber 28 is then pressurized to the pre-determined pressure(s), thus subjecting 12 the food to the pre-determined pressure(s) within chamber 28, and the pre-determined pressure(s) are each held within chamber 28 for the corresponding pre-determined amount of time.

Referring again to FIG. 1, once the food has been subjected 12 to the pre-determined pressure(s) for the pre-determined amount of time, the food is released 30 from the pre-determined pressure(s) such that the food is no longer subjected to the pre-determined pressure(s). In some embodiments, once released 30, the food can be packaged 32 for, for example, storage, transport to a retailer of the food, and/or transport directly to a consumer of the food. In other embodiments, the food is packaged 32 while being subjected 12 to the pre-determined pressure(s). In embodiments wherein the food is subjected 12 to the pre-determined pressure(s) using a pressure vessel, such as, but not limited to, pressure vessel 26 (shown in FIG. 4), after the food has been subjected 12 to the pre-determined pressure(s), chamber 28 is de-pressurized and the food is removed therefrom. In at least some embodiments, to facilitate preventing bacterial growth and/or spore formation on the food, the packaged, prepared food is refrigerated for distribution.

In some embodiments, the food is prepared 34 before being subjected 12 to the pre-determined pressure(s). For example, in some embodiments, the food may be chilled 35 to any suitable temperature before being subjected 12 to the pre-determined pressure(s). In other embodiments, the food may be steamed, boiled, or otherwise heated 37 to any suitable temperature before being subjected to the pre-determined pressure(s). Pre-heating 37 or pre-chilling 35 the food may facilitate subjecting 12 the food to the pre-determined pressure(s) at a temperature that is different than an ambient and/or atmospheric temperature. In addition or alternative to pre-heating 37 and/or pre-chilling 35 the food, in some embodiments, the food is heated 37 and/or chilled 35 while being subjected 12 to the pre-determined pressure(s). After the food is initially prepared 34, the prepared food is then inserted or filled into a flexible package that can withstand the pre-determined pressure(s). Moreover, in some embodiments, after being inserted in the package, the food is sealed using for example, vacuum-packaging equipment and/or nitrogen-flushing equipment.

The above-described methods are cost-effective and reliable for processing food for consumption by individuals having difficulty chewing and/or swallowing, such as, but not limited to, human babies, human toddlers, and/or people suffering from dental or muscular dysfunctions, paralysis, neurodegenerative and musculodegenerative disorders, strokes, and/or general geriatric infirmity. For example, the methods described and/or illustrated herein facilitate sterilizing and/or preserving food such that the food is less dangerous and/or harmful to an individual consuming the food and/or has a longer shelf life. For example, the methods described and/or illustrated herein facilitate rendering micro-organisms, their spores, and/or their enzymes less harmful to an individual consuming food and/or to a general quality, such as, but not limited to a taste, texture, and/or shelf-life, of food. Moreover, and for example, the methods described and/or illustrated herein facilitate increasing a shelf-life of food.

Exemplary embodiments are described and/or illustrated herein in detail. The embodiments are not limited to the specific embodiments described herein, but rather, components and steps of each embodiment may be utilized independently and separately from other components and steps described herein. Each component, and each step, can also be used in combination with other components and/or method steps.

When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc.

While the invention has been described in terms of various specific embodiments, those skilled in the art will recognize that the invention can be practiced with modification within the spirit and scope of the claims.

What is claimed is:

1. A method for processing food for consumption by individuals having difficulty at least one of chewing and swallowing, said method comprising:
providing food having a consistency of at least one of a thick liquid, a thick liquid having chunks, and between a thin liquid and a medium liquid;
subjecting the provided food to at least one pre-determined pressure that is above atmospheric pressure for a pre-determined amount of time; and
releasing the food from the pre-determined pressure.

2. A method in accordance with claim 1 wherein the food comprises at least one of baby food and geriatric food.

3. A method in accordance with claim 1 wherein subjecting the food to at least one pre-determined pressure that is above atmospheric pressure comprises subjecting the food to a pressure of between about 100 MPa and about 1000 MPa.

4. A method in accordance with claim 3 wherein subjecting the food to at least one pre-determined pressure that is above atmospheric pressure comprises subjecting the food to a pressure of between about 400 MPa and about 800 MPa.

5. A method in accordance with claim 1 wherein subjecting the food to at least one pre-determined pressure that is above atmospheric pressure comprises subjecting the food to the pre-determined pressure for between about five minutes and about fifteen minutes.

6. A method in accordance with claim 1 wherein subjecting the food to at least one pre-determined pressure that is above atmospheric pressure comprises channeling the food through a conduit having a pressure difference between an inlet and an outlet of the conduit.

7. A method in accordance with claim 1 wherein subjecting the food to at least one pre-determined pressure that is above atmospheric pressure comprises applying pressure to the food using a piston assembly.

8. A method in accordance with claim 1 wherein subjecting the food to at least one pre-determined pressure that is above atmospheric pressure comprises:
positioning the food within a pressure chamber;
pressurizing the pressure chamber to the pre-determined pressure that is above atmospheric pressure to subject the food to the pre-determined pressure; and
holding the pre-determined pressure for a pre-determined period of time to subject the food to the pre-determined pressure for the pre-determined amount of time.

9. A method in accordance with claim 8 wherein releasing the food from the pre-determined pressure comprises:
de-pressurizing the pressure chamber; and
removing the food from the pressure chamber.

10. A method in accordance with claim 1 further comprising chilling the food before subjecting the food to the pre-determined pressure.

11. A method in accordance with claim 1 further comprising heating the food before subjecting the food to the pre-determined pressure.

12. A method in accordance with claim 1 wherein the food is at least one of organic and does not include any preservatives.

13. A method for processing food for consumption by individuals having difficulty at least one of chewing and swallowing, said method comprising:
providing food having a consistency of at least one of a thick liquid, a thick liquid having chunks, and between a thin liquid and a medium liquid;
subjecting the provided food to at least one pre-determined pressure that is above atmospheric pressure for a pre-determined amount of time;
releasing the food from the pre-determined pressure; and
packaging the food.

14. A method in accordance with claim 13 wherein the food comprises at least one of baby and geriatric food.

15. A method in accordance with claim 13 wherein subjecting the food to at least one pre-determined pressure that is above atmospheric pressure comprises subjecting the food to a pressure of between about 100 MPa and about 1000 MPa.

16. A method in accordance with claim 13 wherein subjecting the food to at least one pre-determined pressure that is above atmospheric pressure comprises subjecting the food to a pressure of between about 400 MPa and about 800 MPa.

17. A method in accordance with claim 13 wherein subjecting the food to at least one pre-determined pressure that is above atmospheric pressure comprises subjecting the food to the pre-determined pressure for between about five minutes and about fifteen minutes.

18. A method in accordance with claim 13 wherein subjecting the food to at least one pre-determined pressure that is above atmospheric pressure comprises channeling the food through a conduit having a pressure difference between an inlet and an outlet of the conduit.

19. A method in accordance with claim 13 wherein subjecting the food to at least one pre-determined pressure that is above atmospheric pressure comprises applying pressure to the food using a piston assembly.

20. A method in accordance with claim 13 wherein subjecting the food to at least one pre-determined pressure that is above atmospheric pressure comprises:
positioning the food within a pressure chamber;
pressurizing the pressure chamber to the pre-determined pressure that is above atmospheric pressure to subject the food to the pre-determined pressure; and
holding the pre-determined pressure for a pre-determined period of time to subject the food to the pre-determined pressure for the pre-determined amount of time.

21. A method in accordance with claim 19 wherein releasing the food from the pre-determined pressure comprises:
de-pressurizing the pressure chamber; and
removing the food from the pressure chamber.

22. A method in accordance with claim 13 further comprising chilling the food before subjecting the food to the pre-determined pressure.

23. A method in accordance with claim 13 further comprising heating the food before subjecting the food to the pre-determined pressure.

24. A method in accordance with claim 13 wherein the food is at least one of organic does not include any preservatives.
